(19) United States
(12) Patent Application Publication
(10) Pub. No.: US 2025/0017361 A1
(43) Pub. Date: Jan. 16, 2025

(54) A DENTAL CLEANING SYSTEM

(71) Applicant: KONINKLIJKE PHILIPS N.V., EINDHOVEN (NL)

(72) Inventors: Gertrude Riette BAKKER-VAN DER KAMP, Den Helder (NL); Joldert Maria BOERSMA, Zuidhorn (NL)

(21) Appl. No.: 18/711,852

(22) PCT Filed: Nov. 3, 2022
(86) PCT No.: PCT/EP2022/080613

§ 371 Date: May 20, 2024

Related U.S. Application Data
(60) Provisional application No. 63/282,065, filed on Nov. 22, 2021.

(51) Int. Cl. A46B 9/04; A46B 5/00; A46B 9/02; A46B 13/02; A46D 1/00; A61C 17/22; A61C 17/34

(52) U.S. Cl. CPC A46B 9/045; A46B 5/0012; A46B 5/0025; A46B 9/026; A46B 13/023; A46D 1/02; A61C 17/228; A61C 17/34; A61C 17/3481

(57) ABSTRACT

A dental cleaning system comprises a first wall element for mounting against the inner, lingual, tooth surfaces of one or both jaws and a second wall element for mounting against the outer, facial, tooth surfaces of said one or both jaws. A drive mechanism couples the first and second wall elements, and imparts a drive vibration of the first and second wall elements towards each other and apart from each other.

### FIELD OF THE INVENTION

This invention relates to dental cleaning systems, in particular to a dental cleaning system in the form of an automatic brushing system based on an actuated mouthpiece.

### BACKGROUND OF THE INVENTION

Automatic tooth brushing using cleaning mouthpieces has become an emerging technology. Several mouthpiece-based dental cleaning systems are available and claim in particular a short brushing time (e.g. 6-30 seconds). These systems hence have speed and ease of use as the main value drivers. The final cleaning result also becomes independent of the user's brushing technique.

The mouthpiece may be defined as the part of a cleaning system which resides inside the mouth and is fitted to the teeth. Typically this is an arch to cover the teeth of a jaw or a pair of arches to cover the teeth of both jaws. The system will typically have other parts which remain external to the mouth, in use. Each arch of the mouthpiece for example has a base and side walls, with cleaning bristles (typically formed as tufts of bristles).

A dental cleaning system of this type for example comprises a mouthpiece which fits over the teeth of one or both jaws, with cleaning bristles facing the teeth. The mouthpiece or just the bristles are driven to move or vibrate relative to the teeth to provide a brushing action.

One issue that has been found is a lack of cleaning effectiveness due to a lack of contour following of different jaw geometries. In particular, there is a lot of variation in the arch shape of teeth between persons. The final cleaning result will become strongly dependent on the fit of the mouthpiece to the teeth of the user.

In order to have a brushing mouthpiece that fits a large number of people, a flexible mouthpiece is needed which can easily adapt to the shape of a tooth arch, for example to tolerate variations in tooth dimensions and dental arc shapes.

The mouthpiece needs to transfer the forces and movement from an actuator to the bristle field within the arch, and the bristle field in turn needs to transfer these forces and movements to the plaque layer to enable it to be removed. If a mouthpiece is too flexible (to enable it to fit different users), it might absorb all the brushing movement when it is activated and then make the brushing less effective.

Most brushing mouthpieces are made from a one-piece silicone component which is vibrated to implement the brushing. The silicone bristles are quite large in diameter (when compared to the bristles of electric or manual toothbrushes). When this silicone mouthpiece adapts to the mouth it is inserted in, it can result that many spots are not in contact with the bristles or the bristles are bend too much and do not apply enough pressure to clean the tooth surface.

The motion made in a mouthpiece is typically very small. A small sweeping movement with bristles that are very flexible will result in no movement at all when pressure is applied to the tips. The bristles will instead move at the base, but the contact force at the tip will be cancelled out by the contact force with the tooth so inhibiting movement of the bristle tips over the tooth surface.

Mouthpieces are for example formed as an H frame (to fit over both jaws) or as two U frames. The bristles thus extend in opposite directions from the two sides of the U-frame or H-frame. This makes manufacture difficult (when the bristles on one side have been placed, it becomes difficult to reach the bristles at the other side).

There is a need for an improved dental cleaning system, for addressing some or all of the issues outlined above.

### SUMMARY OF THE INVENTION

The invention is defined by the claims.

According to examples in accordance with an aspect of the invention, there is provided a dental cleaning system, comprising:
a first wall element for mounting against the inner, lingual, tooth surfaces of one or both jaws;
a second wall element for mounting against the outer, facial, tooth surfaces of said one or both jaws; and
a drive mechanism for coupling the first and second wall elements, and imparting a drive vibration of the first and second wall elements at least including a component towards each other and apart from each other.

This device has an inner wall element which extends against and around the inner tooth surfaces and an outer wall element which extends against and around the outer tooth surfaces. The cleaning action is implemented by moving the two wall elements together and apart, thereby pushing cleaning elements against the tooth surfaces rather than brushing across the tooth surfaces. However, this does not exclude lateral movement of the cleaning elements as well.

By providing separate wall elements around the inner and outer surfaces, they are more easily deformed to match the jaw shape, for example because there is no continuous coupling between the wall elements to form a U-shape, which increases the stiffness. However, the cleaning function remains effective because it is based at least in part on an in/out motion for example for tapping cleaning elements against the tooth surfaces.

The first and second wall elements preferably each comprise a cleaning arrangement for cleaning the tooth surfaces.

The first and second wall elements are preferably independently manufactured units, and they are then assembled together to form the cleaning system. This makes the manufacture of the cleaning system easier, for example it becomes easier to provide bristles or other cleaning elements on these wall elements.

The first and second wall elements for example each comprise a flat carrier which is deformable to match the general contour of the tooth surfaces. The flat wall elements have flat brushing surfaces which can be easily bend when they need to adapt when inserted in the mouth, and the flat surfaces again simplify the integration of a cleaning arrangement such as bristles or bristle tufts on these surfaces. The wall elements may instead have a single axis of curvature instead of a flat surface, again to make manufacture and formation of cleaning elements as simple as possible.

The wall elements may each comprise a series of segments elastically coupled together. This facilitates providing the desired deformability around the tooth arch shape. Each segment for example has a rectangular shape. The segments may be coupled by integrated hinges or by separate coupling elements.

The first and second wall elements are for example coupled together by the drive mechanism. Thus, the drive mechanism has a function of assembling the system as well as driving the movement of the wall elements.

The first wall element is, for example, for mounting against the inner, lingual, tooth surfaces of both jaws and the second second wall element is for mounting against the outer, facial, tooth surfaces of both jaws. Thus, a single inner wall element and a single outer wall element are provided for both jaws.

Instead, separate first and second wall elements may be provided for the top jaw and for the bottom jaw. This enables the position of the two wall assemblies to be independent for the two jaws. They may still be coupled together to form a single system, but with relative movement allowed between the two wall assemblies.

The first and second wall elements for example each comprise a bristle arrangement (as the cleaning arrangement mentioned above), with the bristle arrangement of each wall element facing inwardly towards the other wall element. The bristle arrangements for example comprise silicone or nylon bristles and they may be formed as tufts of multiple bristles or as individual spaced bristles.

The bristle arrangement for example comprises bristles at different heights up the respective wall element. Thus different bristles are for different parts of the tooth surface.

The bristle lengths at the different heights are for example matched to a tooth type at the respective position around the first and second wall elements. Thus, the bristle profile is selected to enable contact with the surfaces of differently-shaped teeth.

The drive mechanism for example comprises an actuator positioned between the first and second wall elements for pulling the first and second wall elements together and/or pushing them apart. The actuator may for example apply one type of motion, and the engagement with the teeth, or a return spring arrangement, may provide the opposing type of motion.

In this case, the drive mechanism is for example located between the first and second wall elements and between the upper and lower jaws. The user for example bites down on the drive mechanism to hold the system in place. The drive mechanism is for example provided with a cleaning arrangement for the occlusal tooth surfaces.

The drive mechanism may instead comprise an actuator located inwardly of the first wall element or outwardly of the second wall element for pulling the first and second wall elements together or pushing them apart.

The actuator for example comprises a bellows, and the bellows may be positioned between the first and second wall elements or to one side of one of the side walls.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a typical known configuration of a dental cleaning system;

FIG. 2 shows that different jaw types have different shapes;

FIG. 3 shows the typical structure of the channel for one jaw;

FIG. 4 shows an H-frame design on the left and two U-frame designs on the right;

FIG. 5 shows a dental cleaning system in accordance with an example of the invention;

FIG. 6 shows that different teeth have different inner and outer tooth shapes;

FIG. 7 shows a first way to implement the drive mechanism;

FIG. 8 shows a second way to implement the drive mechanism;

FIG. 9 shows an implementation of the drive mechanism of FIG. 7 in more detail;

FIG. 10 shows a first implementation of the drive mechanism of FIG. 8;

FIG. 11 shows a second implementation of the drive mechanism of FIG. 8;

FIG. 12 shows a cross section of the system in use, wherein the top image shows a cross section at the incisor area and the bottom image shows a cross section at the molar area;

FIG. 13 shows a perspective view of the system of FIG. 12; and

FIG. 14 a portion of the system in more detail.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a dental cleaning system comprising a first wall element for mounting against the inner, lingual, tooth surfaces of one or both jaws and a second wall element for mounting against the outer, facial, tooth surfaces of said one or both jaws. A drive mechanism couples the first and second wall elements, and imparts a drive vibration of the first and second wall elements towards each other and apart from each other.

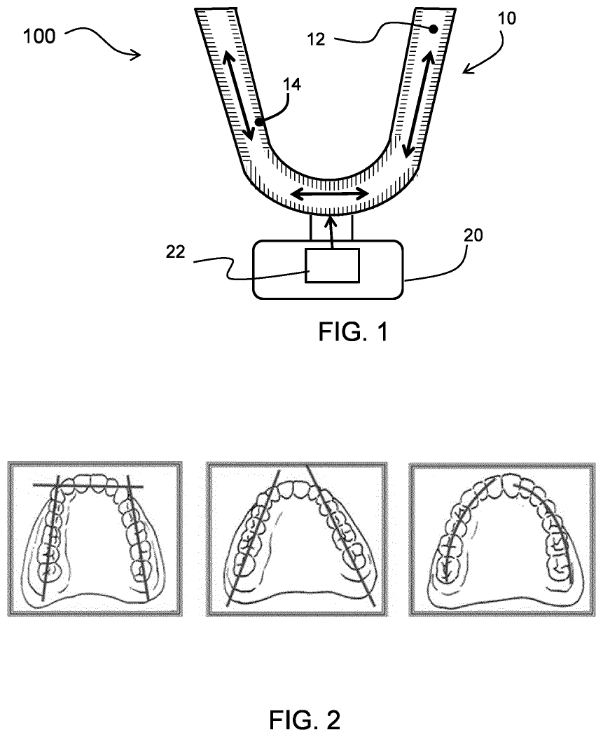

FIG. 1 shows one channel of typical mouthpiece-based dental cleaning system. The system comprises a mouthpiece 10 for insertion in the mouth of the user and an external part 20 for positioning outside the mouth of the user, in front of the user's mouth. The external part 20 for example functions as a handle of the system.

The mouthpiece comprises a first U-shaped channel 12 for receiving the teeth of one jaw, and a second U-shaped channel for receiving the teeth of the other jaw. FIG. 1 is for example looking down on the first channel 12 which open to the top, and the second channel is underneath, open to the bottom.

The overall mouthpiece is bitten onto by the user with their teeth in the two channels. The system may instead have only one channel, in which case the cleaning may be performed one jaw at a time.

The channel 12 comprises a cleaning arrangement 14 such as bristles that face the teeth of the user within the mouthpiece channel. In a conventional design, the bristles are driven parallel to the tooth surfaces as shown by the arrows.

The external part 20 has an actuator 22 for applying movement to an inner arch and/or an outer arch of the channel shape (relative to a fixed base). For a system with two U-shaped channels, a shared actuator may be used.

Teeth have many different shapes. FIG. 2 shows a square jaw shape (left image), a tapered jaw shape (middle image) and an ovoid jaw shape (right image).

To create a mouthpiece that fits a large number of people, such as the shapes shown in FIG. 2, the mouthpiece needs to be designed to easily cope with this variation in tooth dimensions and dental arc shapes.

The mouthpiece also needs to transfer the forces/movement from the actuator 22 towards the cleaning arrangement, which in turn needs to transfer these forces/movement to the plaque layer to get it removed. If the mouthpiece is too flexible, it might absorb all the brushing movement when it is activated.

The typical motion made in the mouthpiece is very small. A small sweeping movement with bristles that are very flexible can however result in no movement at all over the tooth surface when pressure is applied to the tips. The bristles will move at the base, but the contact force at the tip will be cancelled out by the contact force with the tooth.

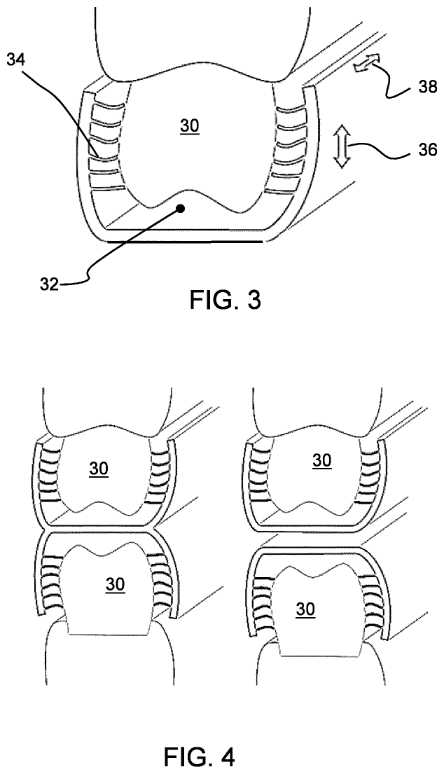

FIG. 3 shows the typical structure of the channel for one jaw. The teeth 30 are received in the channel 32, and there are bristles 34 at least at the inner-facing parts of the side walls of the channel. The channel for example moves up and down relative to the tooth surface (arrow 36) and laterally along the tooth surface (arrow 38) to implement a brushing function.

Two channels as shown in FIG. 3 may be used for the two jaws, or an H-frame design may be used.

FIG. 4 shows an H-frame design on the left and two U-frame designs on the right.

The manufacture of the bristles is complicated by the channel shape.

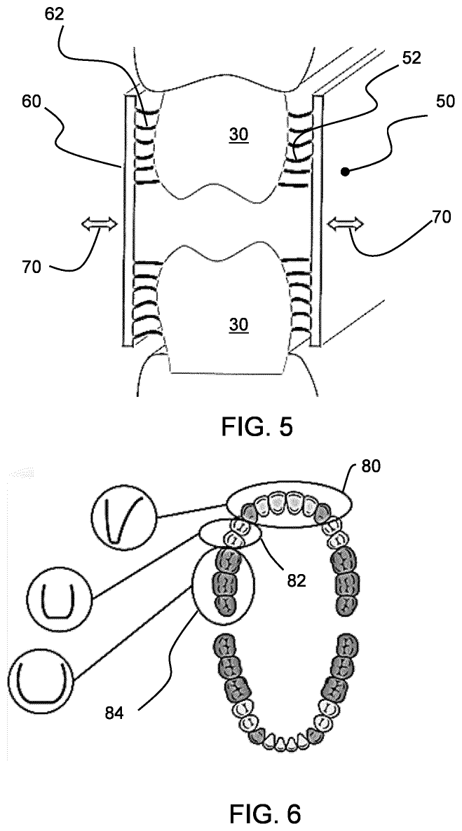

FIG. 5 shows a dental cleaning system, comprising a first wall element 50 for mounting against the inner, lingual, tooth surfaces and a second wall element 60 for mounting against the outer, facial, tooth surfaces. In the example shown, the wall elements extend between both jaws and so are against the tooth surfaces of both jaws. They may however be designed for one jaw only. They may extend full around one or both jaws but they could equally be provided only around a sub-set of the teeth of a jaw.

The wall elements 50,60 are for example stiff in the height direction, but flexible in the horizontal plane. They may for example be formed of a thermoplastic elastomer.

The wall elements may be continuous around the tooth arch or they may be segmented to enable easier following of the dental arch. The segments are then elastically coupled together. This elastic coupling may for example be achieved by the drive mechanism which may extend around the full length of the wall elements. Instead of separate segments, there may be living hinges, i.e. a continuous wall element but formed into integrally connected segments by virtue of locally lower stiffness regions at which local deformation takes place to adapt the shape of the mouthpiece.

The first and second wall elements 50,60 are driven to vibrate towards each other and apart from each other as shown by arrows 70. The driving is by means of a drive mechanism, explained in more detail below. The movement relative to the teeth is thus a lateral tapping motion instead of a sweeping motion.

The tapping movement is found to have a better cleaning result, since the movement is less easily cancelled out by the friction between cleaning arrangement and the teeth, such as between bristle tips and the teeth.

However, it is also possible to implement a sweeping motion in combination with a lateral tapping motion. For example, a bellows may be used that expands differently along its length causing a lateral movement of the walls, in combination with the tapping motion.

By providing separate wall elements around the inner and outer surfaces (instead of an integral channel shape), they are more easily deformed to match the jaw shape. Thus, they follow an arch shape, but they do not by themselves define the channel.

The first wall element 50 has a first cleaning arrangement, for example of bristles 52 for cleaning the inner tooth surfaces and the second wall element has a second cleaning arrangement, for example of bristles 62 for cleaning the outer tooth surfaces.

The bristles can be formed as straight bristles, and the formation of tufts of bristles can be performed using well-known technologies, with no complicated 3D shapes needed. Different types of bristles may be used, for example for the tooth surfaces and for interdental spaces.

The first and second wall elements are independently manufactured units, and they are then assembled together to form the cleaning system. This simplifies the manufacture of the bristles which project from the wall elements. The bristles are formed before assembly of the final mouthpiece. Preferably the bristles are formed when the wall elements are flat, and they are for example formed by injection molding.

The wall elements for example comprise a generally rectangular carrier which is deformable to match the general contour of the tooth surfaces. Before deformation, there are flat brushing surfaces which can be easily manufactured and can then be bent into the desired arch shapes, and further adapted to the particular user when inserted in the mouth. The flat surfaces again help to provide tufted bristles using standard available tufting technologies. This design can result in a better contact between the cleaning bristles and the tooth surfaces resulting in a better cleaning performance.

As shown in FIG. 6, different teeth have different inner and outer tooth shapes. The tooth shapes are shown for the incisors and canines 80, premolars 82 and molars 84.

The lengths of the bristles at different heights up the teeth can thus be designed to create a shape profile matching the tooth shape. For example, at the back of the front teeth, the bristles will form a more hollow curve.

The first and second wall elements 50, 60 are coupled together by a drive mechanism. Thus, the drive mechanism has a function of assembling the system as well as driving the movement of the wall elements.

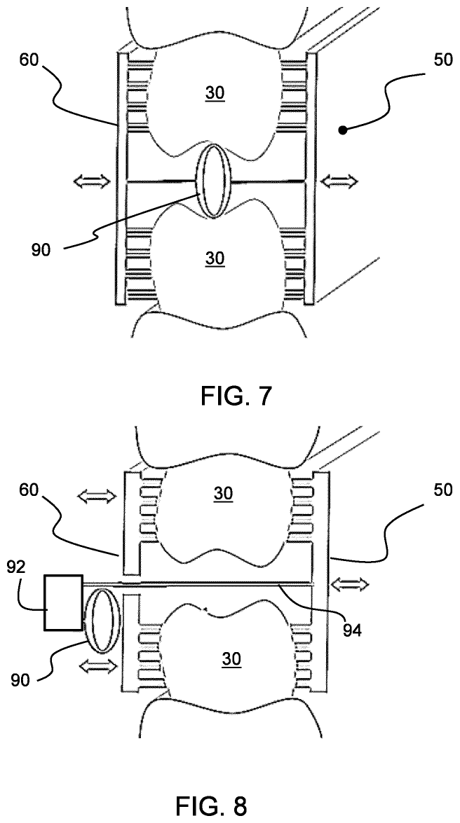

FIG. 7 shows a first way to implement the drive mechanism 90. The drive mechanism 90 comprises an actuator positioned between the first and second wall elements 50, 60. It pulls the first and second wall elements 50, 60 together or pushes them apart. The assembly will self-center on the teeth such that an equal force is applied by the mouthpiece to the inner and outer tooth surfaces. For an arrangement which covers the teeth of both jaws, as shown, the drive mechanism 90 is located between the first and second wall elements as well as between the upper and lower jaws. The user can thus bite down on the drive mechanism 90 to hold the system in place. The drive mechanism is for example provided with a cleaning arrangement (not shown) for the occlusal tooth surfaces.

FIG. 8 shows a second way to implement the drive mechanism 90. The drive mechanism 90 comprises an actuator positioned outwardly of the second wall element 60 for pulling the first and second wall elements together or pushing them apart. It could equally be positioned inwardly of the first wall element. The drive element is positioned between the second wall element and a pusher 92, and the pusher connects to the first wall element by a connecting rod 94. When the actuator expands, the gap between the pusher 92 and the second wall element increases, and this pulls the first wall element 50 towards the second wall element, thus reducing the gap between the two wall elements.

The actuator may be any device that can create a change in distance between two components, which can then translate to a change in spacing between the first and second wall elements. The actuator may be a hydraulic actuator (for example electrically driven) such a bellows driven by a pump, or an electromechanical actuator such as a motor.

The drive mechanism may instead be located away from the mouthpiece, for example in the form of an actuator in a handle of the mouthpiece (e.g. as shown in FIG. 1), wherein a frame transfers the actuation from the actuator in the handle to the wall elements on the mouthpiece.

In the case of a bellows, it may for example bend in the plane perpendicular to the actuation direction, and hence follow the dental arch of the user. The bellows is for example formed of silicone.

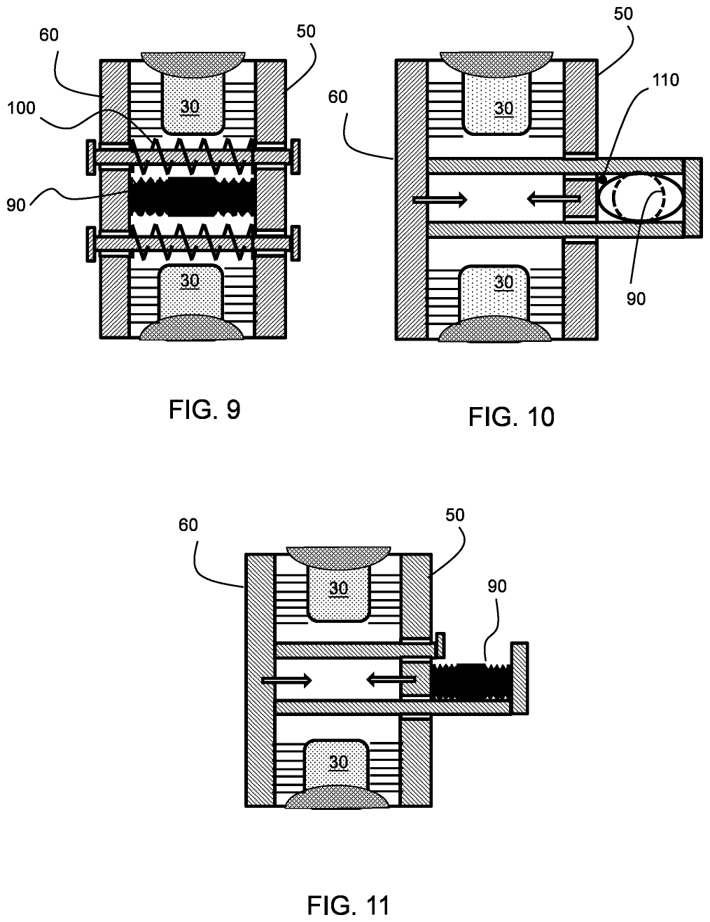

FIG. 9 shows an example of the drive mechanism of FIG. 7 in more detail.

The actuator 90 comprises a pre-shaped bellows which pushes the wall elements apart. In order to bring the wall elements back together when the bellows pressure is released, a spring arrangement 100 is provided.

FIG. 10 shows a first implementation of the drive mechanism of FIG. 8 in more detail. The actuator 90 comprises a bellows mounted in a chamber 110, which constrains the expansion so that it takes place in one (lateral) direction only. Thus, a simpler bellows design may be used, such as a simple tube. When the bellows pressure is released, the cleaning arrangement itself, in particular its engagement with the teeth, provides the force to move the wall elements apart.

FIG. 11 shows a second implementation of the drive mechanism of FIG. 8. The actuator 90 comprises a pre-shaped bellows which functions as a linear actuator which pushes the wall elements together, by being located outside the wall elements. When the bellows pressure is released, the cleaning itself again provides the force to move the wall elements apart.

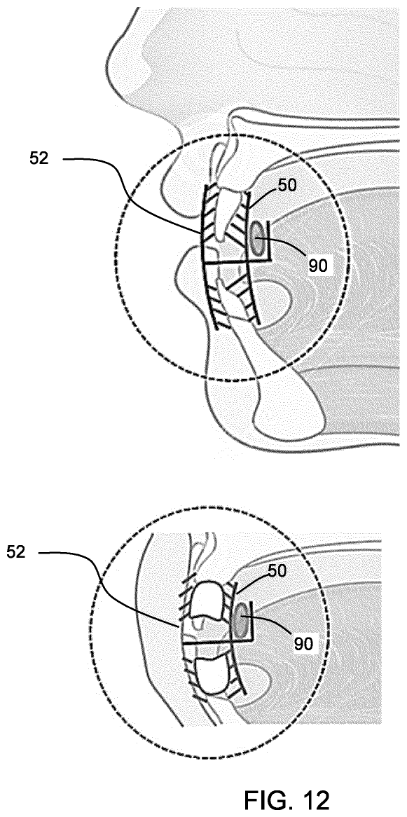

FIG. 12 shows a cross section of the system in use. The top image shows a cross section at the incisor area and the bottom image shows a cross section at the molar area. In this example, the actuator 90 comprises a tubular bellows located at the inside of the first wall element 50.

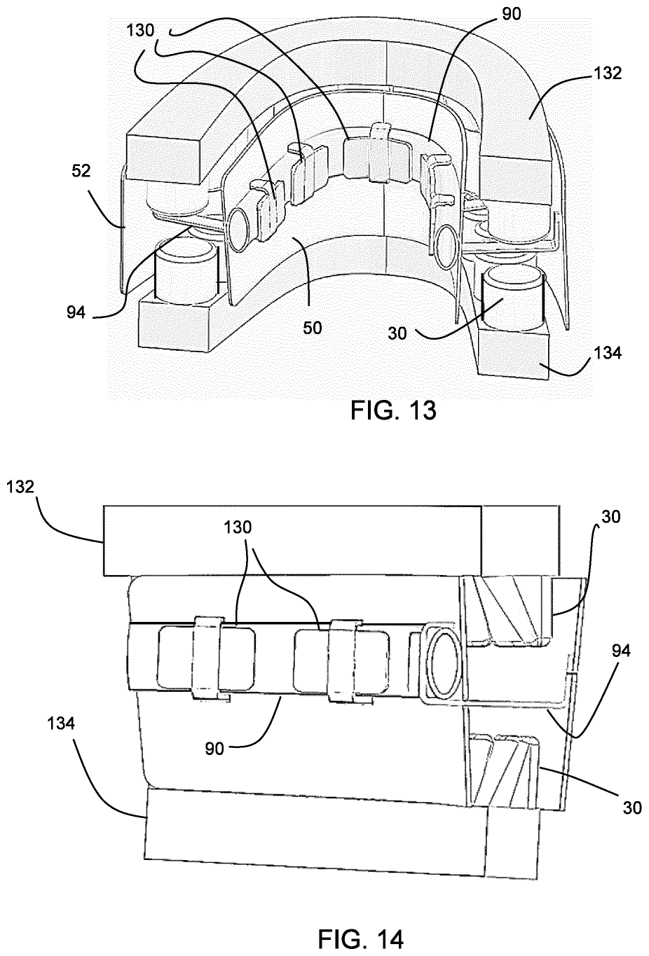

FIG. 13 shows a perspective view of the system of FIG. 12.

The drive mechanism 90, in the form of a tubular bellows actuator, extends around the length of the first wall element 50. Coupling pieces 130 are spaced along the length of the first wall element, and these provide the connecting rods 94 which extend to the second wall element 60.

FIG. 13 schematically represents the upper jaw 132, lower jaw 134 and teeth 30.

As shown in FIG. 14, the tubular bellows can slide relative to the connecting rods 94 to allow shape adjustment. Thus, the bellows is free to slide within a form of gutter defined by the connecting pieces 130.

The system has easy assembly, and the bellows can easily deform to enable the mouthpiece to adapt to the dental arch.

Despite the flexibility of the wall elements, the design can be provided with sufficient stiffness along the dental arch to enable user to move the mouthpiece over the dental arch.

The Eigen frequency of the bristles and wall elements can be designed taking account of the pump frequency in order to obtain a resonant system.

As explained above, the drive vibration of the first and second wall elements at least includes a component towards each other and apart from each other. It may also include a sweeping motion over the tooth surfaces. This may for example be achieved by using a hinge arrangement which converts the inward/outward relative motion into a relative rotation between the two arch shapes, giving a sliding component relative to the teeth as well as a tapping component.

There may be a single actuator for pulling the two side walls together and pushing them apart, but there may also be multiple actuators, so that some regions can be pulled together and other regions can be pushed apart. This also gives more freedom to induce a sweeping motion across the teeth.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A dental cleaning system, comprising:
a first wall element for mounting against the inner, lingual, tooth surfaces of one or both jaws;
a second wall element for mounting against the outer, facial, tooth surfaces of said one or both jaws; and
a drive mechanism for coupling the first and second wall elements, and imparting a drive vibration of the first and second wall elements at least including a component towards each other and apart from each other.

2. The system of claim 1, wherein the first and second wall elements each comprise a cleaning arrangement for cleaning the tooth surfaces.

3. The system of claim 1, wherein the first and second wall elements are independently manufactured units.

4. The system of claim 1, wherein the first and second wall elements each comprise a flat carrier which is deformable to match the general contour of the tooth surfaces.

5. The system of claim 4, comprising bristle fields mounted on, or integrated as part of, the flat carrier.

6. The system of claim 1, wherein the wall elements each comprises a series of segments elastically coupled together by separate coupling elements or by an integral hinges.

7. The system of claim 1, wherein the first and second wall elements are coupled together by the drive mechanism.

8. The system of claim 1, wherein the first wall element is for mounting against the inner, lingual, tooth surfaces of both jaws and the second wall element is for mounting against the outer, facial, tooth surfaces of both jaws.

9. The system of claim 1, wherein the first and second wall elements each comprise a cleaning arrangement in the form of a bristle arrangement, with the bristle arrangement of each wall element facing inwardly towards the other wall element.

10. The system of claim 9, wherein the bristle arrangement comprises bristles at different heights up the respective arch, wherein the bristle lengths at said different heights are matched to a tooth type at the respective position around the first and second wall elements.

11. The system of claim 1, wherein the drive mechanism comprises an actuator positioned between the first and second wall elements for pulling the first and second wall elements together or pushing them apart.

12. The system of claim 11, wherein the drive mechanism is adapted to be located between the first and second wall elements and between the upper and lower jaws.

13. The system of claim 12, wherein the drive mechanism is provided with a cleaning arrangement for the occlusal tooth surfaces.

14. The system of claim 1, wherein the drive mechanism comprises an actuator located inwardly of the first wall element or outwardly of the second wall element for pulling the first and second wall elements together or pushing them apart.

15. The system of claim 1, wherein the actuator comprises a bellows.
